(19) United States
(12) Patent Application Publication
(10) Pub. No.: US 2015/0036131 A1
(43) Pub. Date: Feb. 5, 2015

(54) HANDHELD DIAGNOSTIC SYSTEM WITH CHIP-SCALE MICROSCOPE AND DISPOSABLE SAMPLE HOLDER HAVING BUILT-IN REFERENCE FEATURES

(71) Applicant: NANOSCOPIA ( CAYMAN), INC., Cayman Islands (KY)

(72) Inventor: Kenneth Edward Salsman, Pleasanton, CA (US)

(21) Appl. No.: 13/959,122

(22) Filed: Aug. 5, 2013

(51) Int. Cl. G01N 21/01

(52) U.S. Cl. CPC G01N 21/01
USPC 356/244

(57) ABSTRACT

A handheld diagnostic system may include a disposable sample holder and an analysis module having a chip-scale microscope. The sample holder may have a transparent portion that may be inserted into the analysis module. The transparent portion may have test chambers for containing respective portions of a biological sample. The transparent portion may also include built-in reference features such as reference surfaces, reference markings, and/or reference structures. The chip-scale microscope may include an image sensor for capturing images of the sample and the reference features as the sample holder is inserted into the analysis module. Images of the reference features may be compared with images of the sample and may be used to determine the color, opacity, reflectivity, cell size, and/or cell concentration associated with the sample. The analysis module may transmit sample imaging data to a portable electronic device.

### BACKGROUND

This relates generally to diagnostic systems and, more particularly, to handheld diagnostic systems with chip-scale microscopes and disposable sample holders having built-in reference features.

Conventional diagnostic systems often require external wet chemistry (e.g., performed in a wet laboratory), and are typically only operated by trained personnel having professional expertise. Conventional diagnostic systems are also limited in their abilities to perform multiple tests simultaneously on a single sample.

Because of these factors, conventional diagnostic systems and microscopic imaging systems are typically non-portable, have high cost-per-test, and are unavailable or inconvenient for patients and care providers to use.

Conventional microscope systems are also limited in their abilities to perform certain tests on a sample. Many types of measurements require more advanced laboratory equipment to achieve a sufficient level of accuracy. For example, colorimetric, opacity, and reflectivity measurements are usually obtained using titration systems and culture analyzers. Cell volume measurements and cell counting procedures are typically performed using a flow cytometer. This type of laboratory equipment is non-portable and expensive, and typically requires laboratory-trained personnel.

It would therefore be desirable to be able to provide improved diagnostic systems with microscopic imaging.

### BRIEF DESCRIPTION OF THE DRAWINGS

FIG. 1 is a diagram of an illustrative diagnostic system having a sample holder and an analysis module for capturing and analyzing magnified images of cells and other biological specimens in accordance with an embodiment of the present invention.

FIG. 2 is a diagram of an illustrative chip-scale microscope in accordance with an embodiment of the present invention.

FIG. 3 is a cross-sectional side view of an illustrative sample holder in accordance with an embodiment of the present invention.

FIG. 4 is a cross-sectional top view of an illustrative handheld diagnostic system having a sample holder and analysis module with a chip-scale microscope in accordance with an embodiment of the present invention.

FIG. 5 is a cross-sectional side view of an illustrative sample holder having reference surfaces for obtaining accurate color, opacity, and reflectivity measurements from a sample using a chip-scale microscope in accordance with an embodiment of the present invention.

FIG. 6 is a cross-sectional side view of an illustrative sample holder having reference surfaces for obtaining accurate color, opacity, and reflectivity measurements from a sample using a chip-scale microscope in accordance with an embodiment of the present invention.

FIG. 7 is a cross-sectional top view of an illustrative sample holder having reference markings outside of the sample imaging frame for determining the size of a sample using a chip-scale microscope in accordance with an embodiment of the present invention.

FIG. 8 is a cross-sectional top view of an illustrative sample holder having reference markings that overlap the sample imaging frame for determining the size of a sample using a chip-scale microscope in accordance with an embodiment of the present invention.

FIG. 9 is a cross-sectional top view of an illustrative sample holder having reference structures outside of the sample imaging frame for determining the size of a sample using a chip-scale microscope in accordance with an embodiment of the present invention.

FIG. 10 is a cross-sectional top view of an illustrative sample holder having reference structures that overlap the sample imaging frame for determining the size of a sample using a chip-scale microscope in accordance with an embodiment of the present invention.

FIG. 11 is a diagram of an illustrative diagnostic system having a sample holder for containing a sample, an analysis module having a chip-scale microscope for capturing magnified images of the sample, and an electronic device for obtaining sample analysis information from the analysis module in accordance with an embodiment of the present invention.

FIG. 12 is a flow chart of illustrative steps involved in operating a handheld diagnostic system of the type shown in FIGS. 1-11 in accordance with an embodiment of the present invention.

### DETAILED DESCRIPTION

Systems such as diagnostic systems may be provided with a disposable sample holder and a handheld, portable analysis module having a chip-scale microscope. The disposable sample holder may have internal flow control structures and mechanisms for moving fluids, samples, particles, reactants and/or reagents from one part of the system to another. The sample holder may have multiple test chambers for performing multiple tests simultaneously on a single sample. The sample holder may be configured to protect the sample from contamination, to protect the user from exposure to infectious agents, and to provide the ability to add reagents to the sample. The analysis module may be configured to receive the sample holder and to capture magnified images of the sample using the chip-scale microscope.

The handheld analysis module may be configured to connect with and provide sample analysis information to an electronic device such as a cellular telephone, a laptop, a tablet computer, or other portable computing device. The electronic device may display images captured by the analysis module, may perform additional image analysis, and/or may control specific functions within the analysis module. The analysis module and/or the electronic device may be configured to communicate sample analysis information from the analysis module over a communications network.

The chip-scale microscope may include an image sensor formed from complementary metal-oxide-semiconductor (CMOS) technology or other suitable image sensor integrated circuit technology. The chip-scale microscope may also include optics for focusing light from the sample onto the image sensor. An interchangeable illumination module in the analysis module may be used to illuminate the sample with a desired light source.

This type of diagnostic system may be used to analyze biological materials, bio-chemical materials, chemical materials, and/or other types of materials, and may be configured to perform spectral imaging operations such as narrow band imaging, multiple discrete band imaging, and fluorescence imaging (e.g., bio-fluorescence imaging as may be used in molecular analysis of biological samples).

The diagnostic system may be capable of performing medically viable diagnostics without requiring external wet chemistry or laboratory-trained personnel, may operate at low cost-per-test, and may be capable of operation in a variety of field environments (e.g., environments in which modern medical facilities are not available or are inconvenient).

The sample holder may have built-in reference features for obtaining accurate colorimetric, opacity, and reflectivity measurements from a sample. The built-in reference features may include reference surfaces having a predetermined color, transmissivity, and/or reflectivity. The reference surfaces may be imaged by the chip-scale microscope and compared with images of the sample to determine the color, opacity, and/or reflectivity of the sample. The sample holder may also include reference features such as reference markings having a known size and spacing or reference objects having a known size and spacing. Images of reference markings or objects may be compared with images of the sample and may be used to determine the magnification of the chip-scale microscope, the size of a sample, the volume of a sample, the size or volume of cells within a sample, and/or other parameter values.

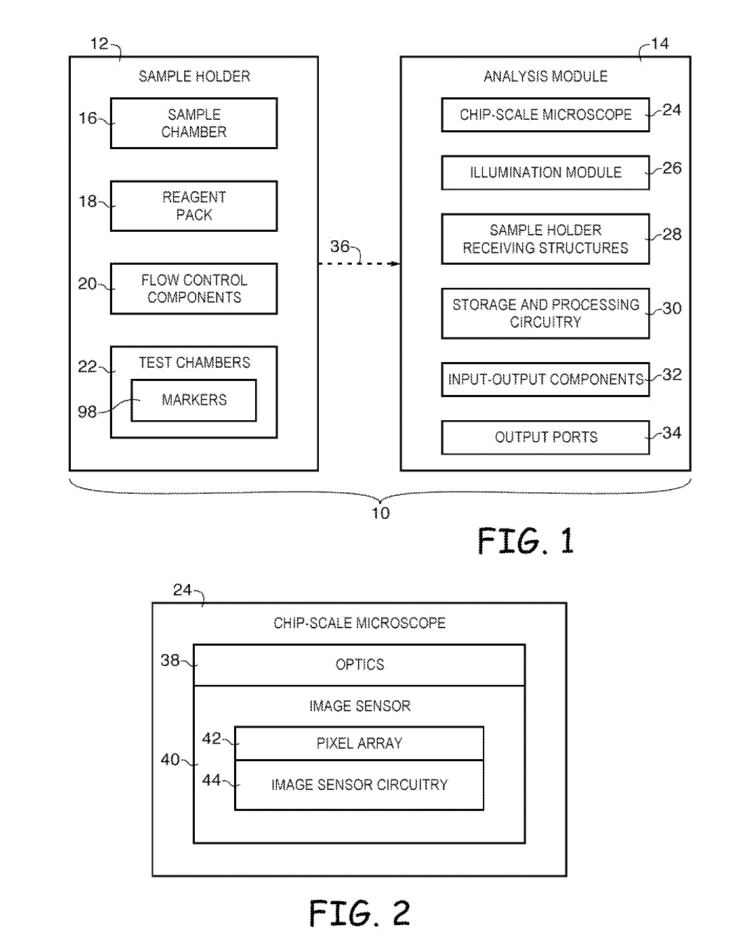

A system of the type that may be used to image and otherwise evaluate cells and other samples such as biological specimens is shown in FIG. 1. As shown in FIG. 1, system 10 may include a sample holder such as sample holder 12 and an analysis module such as analysis module 14. As indicated by arrow 36, analysis module 14 may be configured to receive sample holder 12. Analysis module 14 may be configured to image and analyze samples in different types of disposable sample holders such as sample holder 12.

Sample holder 12 and analysis module 14 may be relatively small in size. For example, sample holder 12 may have a maximum lateral width of less than one inch, less than half of one inch, less than one quarter of one inch, less than four inches, or less than ten inches. Analysis module 14 may have a maximum lateral length of less than three inches, less than two inches, less than one inch, less than four inches, or less than ten inches. Sample holder 12 and analysis module 14 may each be small enough to fit in a user's hand, if desired.

Sample holder 12 may have a sample chamber such as sample chamber 16, one or more reagent packs such as reagent pack 18, flow control components such as flow control components 20, and one or more test chambers such as test chambers 22.

Sample chamber 16 may be configured to receive a sample from a user of system 10. For example, a user may place a swab on which a sample has been collected into sample chamber 16, or a user may place a sample on its own (e.g., a blood sample that has been collected with a lancet) into sample chamber 16. The sample may be a biological sample including cells or other biological elements. If desired, system 10 may be used to analyze and capture high-magnification images of other types of samples (e.g., other biological specimen or other particles or materials). Arrangements in which system 10 is used to image cells are sometimes described herein as an example.

In some situations, it may be desirable to mix the sample with a reagent. Examples of reagents that may be introduced to the sample and allowed to interact with the sample include diluents (e.g., fluids such as ionic fluids), dyes (e.g., fluorescent dyes), or other chemical compounds, biological agents such as antigens, antibodies (e.g., antibodies with dye), phosphors, electrolytes, analyte-specific antibodies, etc. Reagent pack 18 may be used to contain reagents until they are introduced to the sample in sample chamber 16. If desired, there may be one, two, or more than two reagent packs within a single sample holder.

Flow control components 20 may be used to control the flow of a sample within sample holder 12 without requiring electrical power. Flow control components 20 may, for example, include one or more compartments of chemicals configured to react with each other and produce gas which then forces the sample through a channel in the sample holder and distributes portions of the sample into respective test chambers 22 in sample holder 12. For example, flow control components 20 may include a pack or compartment of acetic acid (vinegar) and a pack or compartment of sodium bicarbonate (baking soda). When combined, the sodium bicarbonate and acetic acid may produce carbon dioxide gas which then pushes the sample through the channel in a smooth, continuous, and predictable manner. This type of configuration is advantageous in that it does not require electrical power and also avoids the abrupt jerking of the sample which occurs when a pump is used to control the flow of a sample. However, if desired, other types of flow control structures such as one or more pumps may be used to move the sample from one location in sample holder 12 to another location in sample holder 12.

Test chambers 22 may each be configured to receive a portion of the sample from sample chamber 16. Each test chamber 22 may, for example, contain a different marker such as marker 98 configured to tag a specific chain of DNA, RNA, or protein. For example, markers 98 in test chambers 22 may be configured to locate and mark specific nucleic acids or proteins (e.g., nucleic acids or proteins associated with a bacterium, virus, poison, fungus, parasite, etc.) in the sample with specific colors (e.g., using stains, dyes, and/or fluorescent tagging). Each marker 98 in each test chamber 22 may be used to identify a different bacteria, virus, poison, fungus, or parasite in a single sample, thereby providing system 10 with the ability to perform multiple tests on a single sample simultaneously. There may be one, two, three, four, five, six, or more than six test chambers 22 within sample holder 12. Illustrative examples of substances or structures that may be identified using system 10 include S. aureus, Coagulase-negative staphylococci (CNS), E. faecalis, E. faecium and other Enterococci, E. coli, K. pneumoniae, P. aeruginosa, C. albicans, C. parapsilosis, C. tropicalis, C. glabrata, C. krusei, Listeria, foot-and-mouth disease virus, Methicillin-resistant Staphylococcus aureus (MRSA), and malaria parasites such as P. falciparum and other malaria parasites.

In one suitable embodiment, markers 98 may be configured to tag structures within the sample using a process referred to as immunolabeling. In this type of configuration, markers 98 may include tagged conjugate antibodies that are configured to attach themselves to locations where the corresponding target antigen is found. The conjugate antibodies may be tagged with a fluorescent compound, gold beads, an epitope tag, or an enzyme that produces a colored compound.

In another suitable embodiment, markers 98 may be configured to attach fluorophores to olignoucleotides complementary to the target RNA molecules (as an example).

Reagents and markers in sample holder 12 can be stored in active or in freeze-dried form. Substances stored in freeze-dried form may be activated with the addition of water and/or other reagents.

Sample holder 12 allows the chemistry required for sample processing and the sample itself to be sealed and safely contained once acquired and allows for the processing to be automated within a low-cost structure. If desired, sample holder 12 may be disposed with the sample when the sample analysis is complete or may be used to keep the sample in a safe, contained enclosure until further analysis can be performed in a fully-equipped laboratory. The chemistry, sample processing, and internal structure of a given sample holder may be customized depending on the type of test(s) or analysis being performed. Sample holders 12 may be provided with a common external mechanical structure so that analysis modules 14 are compatible with many different types of sample holders 12, each of which is designed for performing a specific set of tests. Sample holder 12 may be produced inexpensively in high volume and may be disposed of after a single use (if desired).

Analysis module 14 may include chip-scale microscope 24, illumination module 26, sample holder receiving structures 28, storage and processing circuitry 30, input-output components 32, and output ports 34.

Chip-scale microscope 24 may include an image sensor for imaging samples within sample holder 12 and optics such as one or more lenses and/or mirrors for focusing light from the sample onto the image sensor.

Illumination module 26 may include one or more light sources (e.g., one or more light-emitting diodes, arc lamps, lasers, or other suitable type of light source) for illuminating the sample in sample holder 12. Illumination module 26 may also include one or more optical structures such as mirrors, gratings, and/or condenser lenses for focusing light from the light source onto the sample.

Analysis module 14 may include a housing having sample holding receiving structures 28 for receiving sample holder 12. Sample holder receiving structures 28 may include an opening into which sample holder 12 is inserted. The opening may be provided with guide rails or other alignment structures to facilitate insertion of sample holder 12 into analysis module 14. If desired, sample holder receiving structures 28 may include structures for controlling the rate of insertion of sample holder 12 into analysis module 14. For example, the opening into which sample holder 12 is inserted may include a pattern of gears or other structures configured to mate with a corresponding pattern of gears on an external surface of sample holder 12. Such structures may be used to ensure that the rate at which sample holder 12 is guided into analysis module 14 is kept constant or within a given range (if desired). Chip-sale microscope 24 may capture images of the sample as sample holder 12 is being inserted into analysis module 14.

Storage and processing circuitry 30 may include volatile memory (e.g., static or dynamic random-access memory), non-volatile memory (e.g., flash memory), microprocessors, integrated circuits, printed circuit boards, or other circuitry. Storage and processing circuitry 30 may be used for storing, processing, and analyzing image data captured using chip-scale microscope 24, and/or for operating components such as illumination module 26 and input-output components 32.

Storage and processing circuitry 30 may include communications circuitry such as circuitry coupled to output ports 34. Storage and processing circuitry 30 may include wireless communications circuitry for conveying data such as image data, sample analysis information, diagnosis information, etc. to external equipment such as a computer, a handheld electronic device, a cellular telephone, a network router, a network antenna, etc. For example, wireless communications circuitry associated with circuitry 30 may be configured to transmit and/or receive data at WiFi® frequencies (e.g., 2.4 GHz and 5 GHz), Bluetooth® frequencies (e.g., 2.4 GHz), cellular telephone frequencies (e.g., 85-MHz, 900 MHz, 1800 MHz, 1900 MHz, and 2100 MHz), or other frequencies.

Output ports 34 may include one or more universal serial bus (USB) ports, serial ports, audio ports, video ports, etc. coupled to storage and processing circuitry 30.

Data that may be transmitted using ports 34 or wireless communications circuitry associated with circuitry 30 may include identification data associated with a particular analysis module, identification data associated with a particular sample holder, identification data associated with a sample, geographic location data associated with the location of the analysis module, sample analysis information resulting from analysis of a sample within sample holder 12, raw and/or processed imaging data obtained using chip-scale microscope 24, and/or other information. Sample analysis information may, for example, include a medical diagnosis or an identification of which substances or structures were found to be present or absent in the sample.

Illustrative examples of procedures that may be performed using system 10 include whole blood cell analysis, cell counting, Complete Blood Count (CBC), nucleic acid amplification, PNA-FISH® bacterial testing, antigen and antibody infectious disease detection, and other tests. Because system 10 is handheld and portable, such tests may be performed in locations where laboratory facilities are unavailable or inconvenient for a user.

System 10 may provide a user with the ability to interact with analysis module 14. User interactions may include inputting identification information (e.g., information identifying a sample, a sample donor, a geographic location, etc.) and obtaining output information (e.g., reading the result of an analysis performed using chip-scale microscope 24). To implement these interactions, analysis module 14 may have input-output components 32 such as keypads, virtual keypads, buttons, displays, or other suitable input-output components. Input-output components 32 may include circuitry coupled to one or more output ports such as output port 34 mounted in a housing structure.

An illustrative configuration for chip-scale microscope 24 is shown in FIG. 2. As shown in FIG. 2, chip-scale microscope 24 may include optics such as optics 38 and an image sensor (sometimes referred to as an imager) such as image sensor 40. Image sensor 40 may include an array of image pixels such as pixel array 42 and image sensor circuitry such as image sensor circuitry 44. Image sensor circuitry 44 may include row control circuitry, column readout circuitry, analog-to-digital conversion circuitry, and other circuitry associated with capturing raw data using image pixel array 42 of image sensor 40. Circuitry 30 of FIG. 1 may, for example, be used to control imaging functions performed using chip-scale microscope 24.

Optics 38 (sometimes referred to as microscope objective 38) may include optical elements for gathering light from the sample in sample holder 12 and focusing the light onto pixel array 42 of image sensor 40. Optics 38 may include one or more objective lenses, one or more mirrors, one or more layers of glass, and/or other optical structures for focusing light from the sample onto image sensor 40. Optics 38 may, for example, be interposed between the sample (when sample holder 12 is inserted into analysis module 14) and image sensor 40. Optics 38 may be characterized by a magnification of 1000×, 400×, 200×, or other suitable magnification; may be characterized by a numerical aperture of less than 0.5, less than 1.0, less than 1.5, or greater than 1.5; and may be characterized by a working distance of 5 mm, greater than 5 mm, less than 5 mm, less than 10 mm, or greater than 10 mm. Chip-scale microscope 24 may be configured to achieve a depth of field of about 125 microns, about 130 microns, about 120 microns, about 100 microns, less than 100 microns, greater than 100 microns, or greater than 120 microns.

Microscope objective 38 may, if desired, operate with an air medium, thereby eliminating the need for an immersion liquid between the front lens element and the sample. Chip-scale microscope 24 may be equipped to obtain volumetric data using the automatic focus functionality of image sensor 40 without requiring an automated stage.

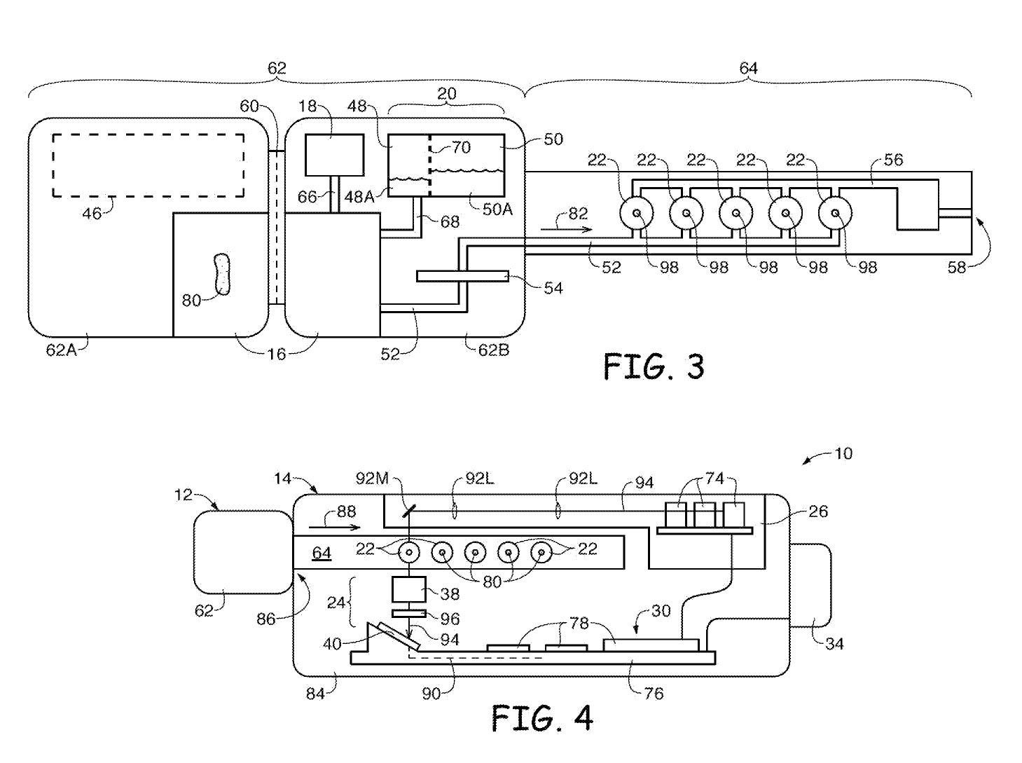

A cross-sectional top view of sample holder 12 is shown in FIG. 3. As shown in FIG. 3, sample holder 12 may include a first portion such as sample-receiving portion 62, and a second portion such as sample imaging portion 64.

Sample-receiving portion 62 may include reagent pack 18, flow control components 20, and sample chamber 16. As described in connection with FIG. 1, reagent pack 18 may be used to contain reagents until they are introduced to the sample in sample chamber 16. Initially, reagent pack 18 may be sealed from sample chamber 16. Upon breaking the seal, reagents in reagent pack 18 may be allowed to interact with a sample such as sample 80 in sample chamber 16 via path 66.

Flow control components 20 may provide a sample distribution mechanism for distributing portions of sample 80 in sample chamber 16 to respective test chambers 22. Flow control components 20 may be implemented as a gas generating component having two adjacent chambers 48 and 50. Chamber 48 may contain a first reactant such as liquid reactant 48A (e.g., acetic acid). Chamber 50 may contain a second reactant such as solid or powder reactant 50A (e.g., sodium bicarbonate). First and second reactants 48A and 50A may be selected to be stable chemicals (e.g., acetic acid (vinegar) and sodium bicarbonate (baking soda), respectively) that generate a gas such as carbon dioxide when mixed.

Chambers 48 and 50 may initially be separated by structural member 70 (e.g., a plastic seal). When seal 70 is punctured or otherwise broken, chemical reactants 48A and 50A may be allowed to interact and a chemical reaction may occur, leading to the release of a significant volume of gas (e.g., carbon dioxide). The gas produced may provide pressure to chamber 16 via path 68, which may in turn move sample 80 in sample chamber 16 through channel 52 in direction 82. Portions of sample 80 may be distributed to respective test chambers 22 in sample imaging portion 64. If desired, a particle filter such as particle filter 54 may be configured to filter sample 80 to prevent certain substances or structures from passing through channel 52 to sample imaging portion 64.

Each test chamber 22 may be coupled to vent line 56. Vent line 56 may allow air to escape via exit port 58 and may be used in regulating the flow of air and the movement of sample 80, if desired.

If desired, other sample distribution mechanisms may be employed to distribute sample 80 in sample chamber 16 to test chambers 22. The use of sodium bicarbonate and acetic acid is merely.

Sample-receiving portion 62 may have a clamshell shape with first and second portions 62A and 62B connected by a bendable joint such as bendable joint 60. With this type of configuration, sample-receiving portion 62 of sample holder 12 may be configurable in open and closed positions. In the open configuration (as shown in FIG. 3), compartments within sample-receiving portion 62 may be sealed. For example, reagent pack 18 may be sealed and compartments 48 and 50 may be sealed and separated from each other. While sample-receiving portion 62 is open, a user may place a sample into sample chamber 16 and may then close sample-receiving portion 62 by bending sample-receiving portion 62 at bendable portion 60. Upon closing sample-receiving portion 62, a protrusion such as protrusion 46 (e.g., a structure having one or more sharp edges) within portion 62 may puncture reagent pack 18 and seal 70, thereby allowing reagents in reagent pack 18 to interact with the sample in sample chamber 16 while also allowing reactants 48A and 50A in compartments 48 and 50 to interact with each other. Sample 80 is mixed with reagents in reagent pack 18 and is moved through channel 52 to test chambers 22. With this type of configuration, the appropriate chemistry and sample processing may automatically occur within sample holder 12 by merely closing sample-receiving portion 62 after placing sample 80 in sample chamber 16.

If desired, sample chamber 16 may include a permeable or semi-permeable cover such as a neoprene membrane through which a needle may be inserted (as an example).

As described in connection with FIG. 1, each test chamber 22 in sample holder 12 may contain a different marker for tagging a specific substance (e.g., via staining, dying, fluorescent tagging, etc.). As an example, one test chamber 22 may contain a marker for tagging foot-and-mouth disease virus, while another test chamber 22 may contain a marker for tagging Methicillin-resistant Staphylococcus aureus (MRSA). Because the sample is automatically distributed to chambers 22 by closing sample-receiving portion 62, the sample may automatically be tagged by different markers in chambers 22, without requiring external wet chemistry or laboratory-trained personnel. Moreover, by simultaneously tagging different portions of a single sample in sample holder 12 with different markers, different types of tests (e.g., tests for different types of bacteria, viruses, fungi, parasites, etc.) may be performed simultaneously on a single sample.

Sample holder 12 may be formed from plastic, glass, metal, carbon fiber and/or other fiber composites, ceramic, glass, wood, other materials, or combinations of any two or more of these materials. Sample imaging portion 64 may be designed for microscopic imaging (e.g., may be partially or fully transparent so that sample 80 in test chambers 22 may be illuminated for microscopic imaging).

FIG. 4 is a cross-sectional top view of system 10 in which sample holder 12 has been inserted into analysis module 14. As shown in FIG. 4, analysis module 14 may include a housing such as housing 84 having an opening such as opening 86. Opening 86 may be have a shape that corresponds to the shape of sample imaging portion 64 of sample holder 12 so that sample imaging portion 64 of sample holder 12 may be inserted into analysis module 14. Sample holder 12 may be engaged with analysis module 14 by inserting sample imaging portion 64 of sample holder 12 into opening 86 in direction 88.

As shown in FIG. 4, output port 34 may be implemented as a USB connector for coupling module 14 to external equipment such as a computer, cell phone, laptop computer, tablet computer, etc. In addition to providing a means for communicating sample analysis information and/or sample imaging data from analysis module 14 to external electronic devices, output port 34 may also be configured to provide power to components within analysis module 14. For example, port 34 may include a power supply for providing power to illumination module 26, image sensor 40, and storage and processing circuitry 30. This is, however, merely illustrative. If desired, electrical components in analysis module 14 may receive power from an external power source.

Storage and processing circuitry 30 may be implemented using a printed circuit substrate such as printed circuit substrate 76, integrated circuits or other electrical components such as electrical components 78, and/or other circuitry in analysis module 14. Image sensor 40 may be coupled to printed circuit board 76 using an array of solder balls (e.g., a ball grid array) or may be coupled to printed circuit board 76 using other mounting techniques. Printed circuit board 76 may include metal traces 90 for electrically coupling image sensor 40 to other circuitry such as integrated circuit 78.

Lighting components 26 may be mounted in analysis module 14 so that light from lighting sources 74 passes through test chambers 22 of sample holder 12 during sample analysis operations. As described in connection with FIG. 1, illumination module 26 may include one or more light sources such as light sources 74 (e.g., one or more light-emitting diodes, arc lamps, lasers, or other suitable type of light source) for illuminating sample 80 in sample holder 12. Light sources 74 may be white light sources or may be configured to emit different colors of light. For example, light source 74 may be white light sources that are provided with different colored filters.

Illumination module 26 may include one or more optical structures such as lenses 92L mirror 92M for focusing light 94 from light source 74 onto sample 80. In response to control signals from control circuitry 30, light sources 74 may produce light 94 of a desired color and intensity. Light 94 may be directed through sample holder 12 (when sample holder 12 is inserted into analysis module 14) towards image sensor 40.

Illumination module 26 may be interchangeable so that different types of microscopy may be performed. For example, a first illumination module may be used to perform fluorescence microscopy using chip-scale microscope 24, and a second illumination module may be used to perform bright field microscopy using chip-scale microscope 24. When it is desired to change the type of microscopy being performed, the first illumination module may be removed from analysis module 14 and the second illumination module may be installed into analysis module 14 (or vice versa).

Light 94 may pass through sample 80 and may be focused onto image sensor 40 using optics 38. As described in connection with FIG. 2, optics 38 may include one or more objective lenses, one or more mirrors, one or more layers of glass, and/or other optical structures for focusing light from sample 80 onto image sensor 40. If desired, one or more optical filters such as optical filter 96 may be interposed between optics 38 and image sensor 40. Like illumination module 26, optical filters in analysis module 14 such as optical filter 96 may be interchangeable so that different types of microscopy may be performed. Illustrative types of filters that may be used in analysis module 14 include longpass filters, colored and/or neutral density filters, absorptive filters, interference filters, dichroic filters, polarization filters, other suitable types of filters, or a combination of any two or more of these types of filters.

After a user injects or otherwise places a sample into test chamber 16 (FIG. 3) and closes sample-receiving portion 62, flow control components 20 may automatically be activated to distribute portions of sample 80 into respective test chambers 22 (as shown in FIG. 4). The user may then insert sample holder 12 into analysis module 14 by sliding sample imaging portion 64 of sample holder 12 into opening 86 of analysis module 14 in direction 88. As sample imaging portion 64 of sample holder 12 moves in direction 88 within cavity 86, each test chamber 22 may pass through light 94 and over image sensor 40. In the configuration shown in FIG. 4, for example, sample 80 in the rightmost chamber 22 will be the first to pass through light 94 over image sensor 40 and will therefore be the first specimen to be imaged with image sensor 40. As the user continues to push sample holder 12 into analysis module 14, sample 80 in the second chamber 22 from the right will pass through light 94 over image sensor 40 and will therefore be the second specimen to be imaged with image sensor 40. In this way, light 94 may successively illuminate sample 80 in each test chamber 22, and images may be successively captured of sample 80 in each chamber 22 as each chamber 22 is moved across the field of view of chip-scale microscope 24. Image sensor 40 may include circuitry for automatically triggering each image capture operation as test chambers 22 move across the field of view of image sensor 40.

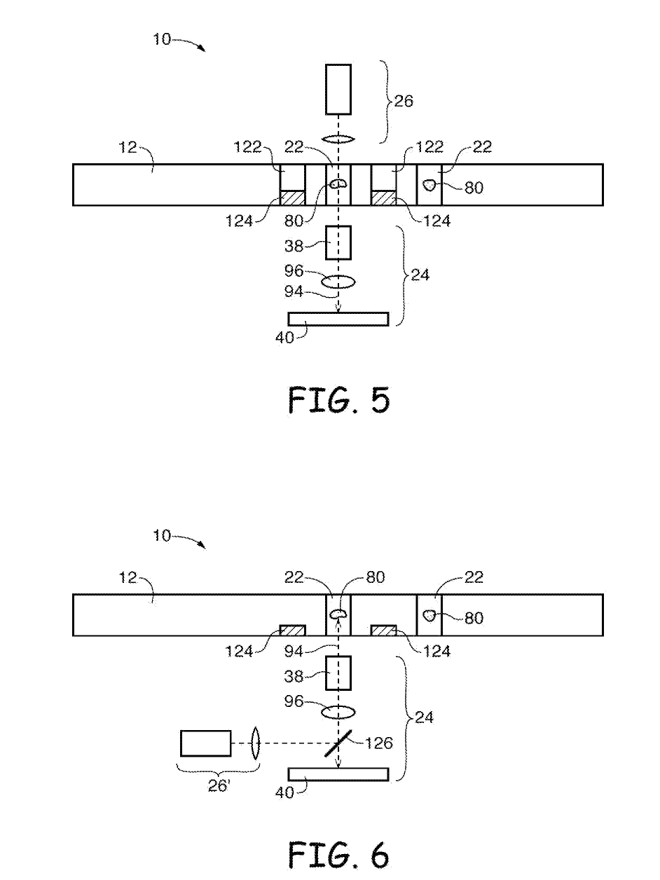

Sample imaging portion 64 of sample holder 12 may have built-in reference features for obtaining accurate color, opacity, and reflectivity measurements from a sample. FIG. 5 is a cross-sectional view of part of system 10 showing how sample holder 12 may have built-in reference features for obtaining accurate color, opacity, and reflectivity measurements from a sample such as sample 80.

As shown in FIG. 5, sample holder 12 may have reference chambers such as reference chambers 122. There may be one, two, three, four, or more than four reference chambers 122 in sample holder 12. Each reference chamber 122 may be interposed between an associated pair of sample chambers 22, or reference chambers 122 may be grouped separately from sample chambers 22.

Each reference chamber 122 may include a reference surface such as reference surface 124. Reference surface 124 may be a surface of sample holder 12 itself or may be a surface of an object or material in reference chamber 122. Reference surface 124 may have known properties that may be compared with measurements obtained from sample 80 in test chambers 22 to determine corresponding properties of sample 80.

Reference surfaces 124 may, for example, have known properties such as known color, known transmissivity, known reflectivity, known absorbance, and/or other known properties. Reference surfaces 124 may be fully transparent or fully opaque, or may be configured to transmit light within a range of wavelengths. Reference surfaces 124 may include white surfaces, red surfaces, blue surfaces, green surfaces, or surfaces of other colors. Light sources in illumination module 26 (e.g., light sources 74 of FIG. 4) may also have known properties and may be calibrated to increase the accuracy of colorimetric measurements, opacity measurements, and reflectivity measurements.

Image sensor 40 may gather reference information from reference surfaces 124 and may gather sample imaging data from sample 80. The reference information may be compared with the sample imaging data to determine information about sample 80. For example, image sensor 40 may compare the reference information with sample imaging data to determine the color of sample 80 based on the known information about reference surface 124 (e.g., based on the known color of reference surface 124). As another example, image sensor 40 may compare the reference information with sample imaging data to determine the transmissivity of sample 80 (e.g., based on the known transmissivity of reference surface 124).

In one suitable embodiment, one reference chamber 122 may contain an optically transparent reference surface 124 and another reference chamber 122 may contain a white reference surface 124. Image sensor 40 may capture images of both the white and the transparent reference surfaces while the reference surfaces are illuminated by illumination module 26. The two reference surfaces may be imaged in the same imaging frame or may be imaged in separate imaging frames. Reference information gathered from the white reference surface and reference information gathered from the transparent reference surface may be compared with each other to determine the white balance of image sensor 40. Knowing the white balance of image sensor 40 may be useful in obtaining accurate color measurements from sample 80 in test chambers 22.

After gathering reference information from the white and transparent reference surfaces, image sensor 40 may gather additional reference information from one or more additional reference surfaces 124. The additional reference surfaces may have known colors. The reference information gathered from colored reference surfaces 124 in reference chambers 122 may be compared with sample imaging data gathered from sample 80 in test chambers 22. If desired, image sensor 40 may gather reference data from reference surfaces 124 and sample imaging data from sample 80 in the same imaging frame or in separate imaging frames. Based on the known white balance of image sensor 40 and based on the color variation between images of sample 80 and images of colored reference surfaces 124, the color of sample 80 may be accurately determined.

The color of reference surfaces 124 need not exactly match the color of sample 80. For example, red and blue reference surfaces may be used to measure the color of a purple or violet sample.

Reference surfaces 124 may also be used in determining the opacity or transmissivity of a sample. For example, the intensity of light 94 received through reference surface 124 may be compared with the intensity of light 94 received through sample 80 and, based on the known transmissivity of reference surface 124 and based on the known intensity of light 94 emitted by illumination module 26, may be used to determine the opacity and/or transmissivity of sample 80.

In some configurations, illumination module 26 may be located on the same side of sample 80 as image sensor 40. With this type of configuration, image sensor 40 may be configured to gather light that is reflected off of sample 80 and off of reference surfaces 124. FIG. 6 is a cross-sectional view of part of system 10 showing how sample holder 12 may have built-in reference features and showing how an illumination module may be located on the same side of sample holder 12 as image sensor 40.

As shown in FIG. 6, illumination from illumination module 26′ and detection by image sensor 40 occur on the same side of sample 80. This type of configuration is sometimes referred to as epi-illumination and can be useful for fluorescence microscopy and for imaging opaque specimens. Illumination module 26′ may lie horizontally at a 90 degree angle to the optical axis of chip-scale microscope 24. Light 94 emitted by illumination module 26′ may strike optical member 126 and may be reflected upwards towards sample 80 in sample holder 12. Optical member 126 may be a plane glass member that is partially reflective and partially transmissive. Optical member 126 may, for example, be partially coated with a reflective material such silver paint. If desired, the transmissive portion of optical member 126 may be coated with an anti-reflection coating. Optical member 126 may be tilted at a 45 degree angle to the path of light emitted by illumination module 26′. Some or all of light 94 that strikes sample 80 may be reflected back towards image sensor 40 and may pass through the transmissive portion of optical member 126. During image capture operations, objective 38 may gather light 94 that is reflected off of sample 80 and focus the light onto image sensor 40.

As described in connection with FIG. 5, reference surfaces 124 may have known properties (e.g., known color, known transmissivity, known reflectivity, known absorbance, and/or other known properties). Reference surfaces 124 may be fully transparent or fully opaque, or may be configured to transmit light within a range of wavelengths. Reference surfaces 124 may include white surfaces, red surfaces, blue surfaces, green surfaces, or surfaces of other colors. Light sources in illumination module 26′ may also have known properties and may be calibrated to increase the accuracy of colorimetric measurements, opacity measurements, and reflectivity measurements.

Color may be measured by comparing the color of light reflected from one or more of reference surfaces 124 with that reflected from sample 80. Opacity and reflectivity may be measured by comparing the intensity of light reflected from one or more of reference surfaces 124 with that reflected from sample 80. Providing sample holder 12 with built-in reference features such as reference surfaces 124 may allow accurate color, opacity, and reflectivity measurements to be obtained from sample 80 using a single handheld diagnostic system such as system 10.

It may also be desirable to be able to determine the level of magnification being used by chip-scale microscope 24. Because the depth of field of image sensor 40 is variable, the magnification of chip-scale microscope 24 may also be variable. Knowing the level of magnification being used during image capture operations may be required to perform cell counting and to determine an accurate size and/or type of cell that is being imaged. This information may also be used to calculate the minimum object size that is observable by chip-scale microscope 24. To provide this information, sample holder 12 may have built-in reference features such as built-in reference markings. The reference markings may be used to determine the number of pixels between reference points or across reference objects in sample holder 12.

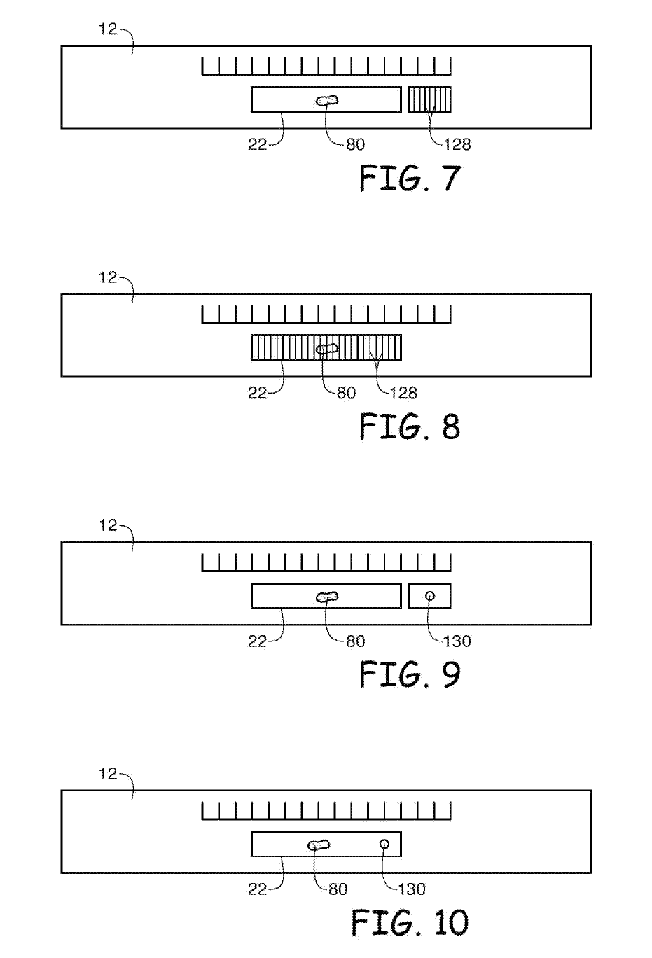

FIG. 7 is a cross-sectional top view of sample holder 12 showing how reference markings such as reference markings 128 may be formed on a surface of sample holder 12 (e.g., in the transparent portion of sample holder 12). There may be two, three, five, ten, less than ten, or more than ten reference markings on sample holder 12. Reference markings 128 may be spaced from each other at regular intervals and may have a known line spacing and line width.

In the example of FIG. 7, reference markings 128 are separate from test chamber 22 and may therefore be imaged in a separate imaging frame from sample 80. For example, image sensor 40 may capture one or more images of reference markings 128 prior to or after capturing images of sample 80. The same level of magnification may be used during reference imaging of reference markings 128 as that used during sample imaging of sample 80. Image sensor 40 may be configured to determine the number of pixels between reference markings 128 and analysis module 14 may use this information to determine the level magnification of chip-scale microscope 24 during that particular series of image capture operations. The level of magnification of chip-scale microscope 24 may in turn be used to determine the size of cells in sample 80 and/or to determine the concentration of cells in sample 80 (i.e., the number of cells within a given volume of sample 80).

If desired, reference markings may be incorporated into the test chamber in which the sample is imaged. FIG. 8 is a cross-sectional top view of sample holder 12 showing how reference features such as reference markings 128 may be located within test chamber 22 of sample holder 12. With this type of configuration, reference markings 128 may be imaged within the sample field of view. Reference markings 128 may overlap sample 80 while being located in a different plane of focus from sample 80 or may be minimally obscurant markings that are visible with sample 80. Analysis module 14 may determine the level of magnification used during an image capture operation based on the number of pixels between reference markings 128.

In another suitable embodiment, sample holder 12 may include reference objects for determining the size of cells in sample 80 and/or for determining the level of magnification of chip-scale microscope 24. FIG. 9 is a cross-sectional top view of sample holder 12 illustrating how sample holder 12 may include reference features such as reference structure 130. Reference structure 130 may be a sphere, cube, or other structure having a known size. There may be one, two, three, or more than three reference structures 130 in sample holder 12.

In the example of FIG. 9, reference structures 130 are separate from test chamber 22 and may therefore be imaged in a separate imaging frame from sample 80. For example, image sensor 40 may capture one or more images of reference structures 130 prior to or after capturing images of sample 80. The same level of magnification may be used during reference imaging of reference structures 130 as that used during sample imaging of sample 80. Image sensor 40 may be configured to determine the number of pixels across reference structures 130 and analysis module 14 may use this information to determine the level magnification of chip-scale microscope 24 during that particular series of image capture operations. This information may in turn be used to determine the size of cells in sample 80 and/or to determine the concentration of cells in sample 80 (i.e., the number of cells within a given volume of sample 80).

If desired, reference structures may be incorporated into the test chamber in which the sample is imaged. FIG. 10 is a cross-sectional top view of sample holder 12 showing how reference features such as reference structures 130 may be located within test chamber 22 of sample holder 12. With this type of configuration, reference structures 130 may be imaged within the sample field of view. Reference structures 130 may, for example, be located in a different plane of focus from sample 80 or may be minimally obscurant structures that are visible with sample 80. Analysis module 14 may determine the level of magnification used during an image capture operation and may determine the size or concentration of cells in sample 80 based on the number of pixels across reference structures 130.

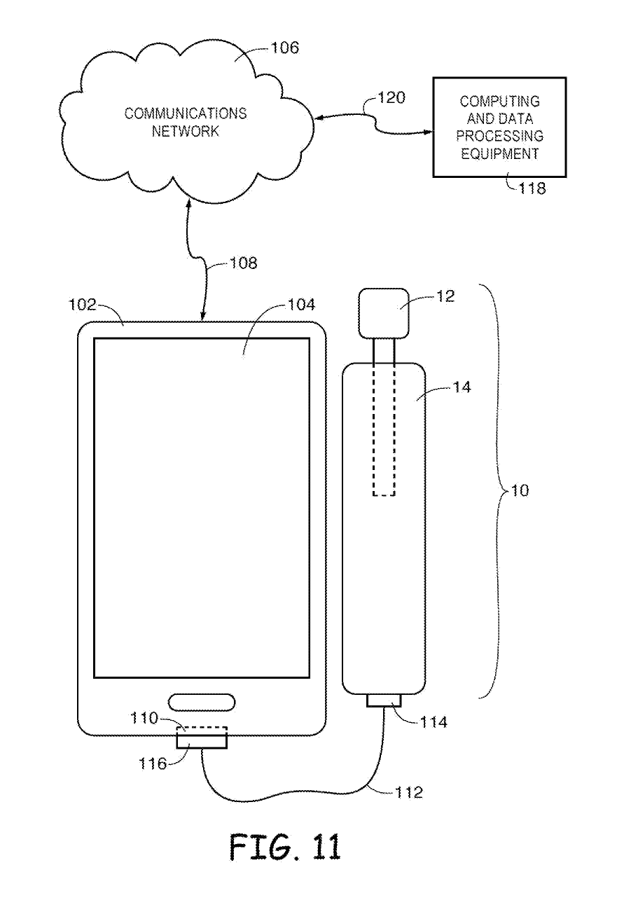

FIG. 11 is a diagram showing how a handheld diagnostic system such as system 10 may be configured to communicate with computing equipment such as computing equipment 102. Computing equipment 102 may be a portable electronic device (e.g., a mobile phone, a personal digital assistant, a laptop computer, a tablet computer, or other computing equipment). Computing equipment 102 may include a display such as display 104 for presenting visual information to a user based on data received from system 10. For example, display 104 may be used in displaying images of samples acquired by system 10 (sometimes referred to as sample image data) and/or may be used in displaying sample analysis information (e.g., may present a list of bacteria, viruses, poisons, fungi, or parasites which were found present in the sample).

Computing equipment 102 may have a user input interface for gathering input from a user and for supplying output to a user. The user input interface may include user input devices such as keyboard, keypads, mice, trackballs, track pads, etc. If desired, display 104 may be touch-sensitive (i.e., display 104 may be a touch screen) and may be used to gather user input from a user. Computing equipment 102 may also include equipment for supplying output such as speakers for providing audio output, status indicator lights for providing visible output, etc.

Computing equipment 102 may include a data port such as data port 110. Data port 110 may be connected to analysis module 14 using a cable such as cable 112. On one end, cable 112 may have a connector such as connector 114 configured to mate with output port 34 of analysis module 14 (FIG. 4). On an opposing end, cable 112 may have a connector such as connector 116 configured to mate with data port 110 of computing equipment 102. Sample image data and/or sample analysis information may be conveyed from analysis module 14 to computing equipment 102 via cable 112. This is, however, merely illustrative. If desired, information may be conveyed from sample analysis module 14 to computing equipment 102 over a wireless network. As another example, data port 110 may be a Universal Serial Bus (USB) port and may be configured to receive output port 34 of analysis module 14 directly (without requiring cable 112).

Computing equipment 102 may be used to analyze sample image data and/or sample analysis information (e.g., to produce images of the sample from raw image data, to produce enhanced images of the sample, to analyze images of the sample to produce sample evaluation information or diagnosis information, etc.). Computing equipment 102 may, if desired, transmit data from system 10 to computing and data processing equipment 118 via communications network 106. Communications network 106 may include wired and wireless local area networks and wide area networks (e.g., the internet).

Computing equipment 102 may be connected to network 106 using a link such as link 108 (e.g., a wired link that uses a modem or wireless link such as a local wireless link), and computing and data processing equipment 118 may be connected to network 106 using a link such as link 120 (e.g., a wired link that uses a modem or wireless link such as a local wireless link). Computing and data processing equipment 118 may be a remote mainframe computer, may be a cloud computing network (i.e., a network of computers on which software can be run from computing equipment 102) or other computing equipment. If desired, computing and data processing equipment 118 may be used to perform advanced analysis on sample image data and/or sample analysis information from system 10 (e.g., advanced analysis that requires more computing power than computing equipment 102 is capable of).

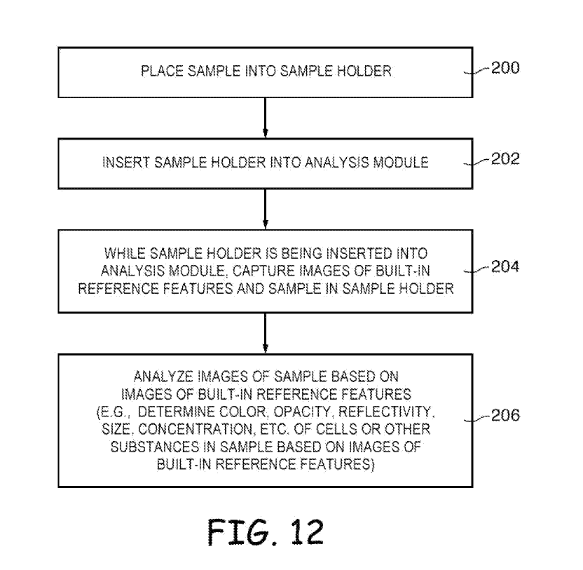

FIG. 12 is a flow chart of illustrative steps involved in using a handheld diagnostic system with a chip-scale microscope and disposable sample holder having built in reference features such as reference surfaces 124 (FIGS. 5 and 6), reference markings 128 (FIGS. 7 and 8), and/or reference structures 130 (FIGS. 9 and 10).

At step 200, a sample may be injected into a sample chamber in a sample holder such as sample chamber 16 in sample holder 12. Portions of the sample may automatically be distributed from the sample chamber to respective test chambers in the sample holder.

At step 202, a user may insert the sample holder into an analysis module such as analysis module 14 of FIG. 4. Circuitry in analysis module 14 may be configured to automatically trigger image capture operations at predetermined spatial or temporal intervals as sample holder 12 is inserted into analysis module 14.

During insertion, built-in reference features in sample holder 12 may pass through the field of view of chip-scale microscope 24 in analysis module 14. Sample 80 may also pass through the field of view of chip-scale microscope 24 during sample holder insertion. At step 204, image sensor 40 of chip-scale microscope 24 may capture images of the sample and of the built-in reference features (e.g., reference surfaces having known color, opacity, and reflectivity, reference markings having a known line spacing and line width, reference structures having a known size, and/or other reference features) as the sample holder is inserted into the analysis module. Reference data (e.g., images of reference features) may be gathered in the same imaging frame that sample data is gathered, or reference data may be gathered in a separate imaging frame from sample data (e.g., by capturing images of reference features prior to or after capturing images of the sample).

At step 206, storage and processing circuitry in analysis module 14 (and/or in computing equipment 102, if desired) may analyze images of the sample based on images of the built-in reference features. This may include, for example, determining a color, opacity, and/or reflectivity associated with the sample using reference surfaces 124 (FIGS. 5 and 6), determining the size and/or concentration of cells or other substances in the sample using reference markings 128 (FIGS. 7 and 8) or reference structures 130 (FIGS. 9 and 10), and/or determining other parameter values based on images of reference features that are built into sample holder 12.

Various embodiments have been described illustrating a handheld diagnostic system for imaging and analyzing cells and other substances. The handheld diagnostic system may include a disposable sample holder for collecting a sample, safely containing the sample, and for presenting the sample to an analysis module having a chip-scale microscope.

The sample holder may include fluid control components for automatically distributing portions of the sample to respective test chambers in the sample holder for imaging. The test chambers may include markers (e.g., dyes, stains, fluorescence markers, etc.) configured to mark or otherwise identify specific nucleic acids or proteins in the sample if present in the sample. The test chambers may be located in a transparent portion of the sample holder

The analysis module may have a housing with an opening. The opening may be configured to receive the transparent portion of the sample holder. While a user inserts the transparent portion of the sample holder into the opening of the analysis module, the chip-scale microscope may capture images of the sample in each test chamber as each test chamber passes through the field of view of the chip-scale microscope.

The analysis module may include an interchangeable illumination module for illuminating the sample and a chip-scale microscope for capturing images of the sample. The chip-scale microscope may include an image sensor having an array of image pixels configured to gather pixel data from the sample. The chip-scale microscope may also include optics such as one or more objective lenses for gathering light from the sample and focusing the light onto the image sensor.

The analysis module may include storage and processing circuitry for processing pixel data and, if desired, analyzing the processed pixel data to produce sample analysis information. The pixel data and/or the sample analysis information may be transmitted to external computing equipment such as a portable electronic device for further analysis and/or for displaying sample analysis information for a user based on the sample images acquired using the chip-scale microscope.

The sample holder may have built-in reference features that are configured to be imaged by the chip-scale microscope. The reference features may be imaged with the sample or may be imaged before or after the sample in the sample holder is imaged. The reference features may include reference surfaces for determining the color, opacity, and reflectivity of a sample and/or the reference features may include reference markings or structures for determining the size and concentration of cells or other substances in the sample.

The foregoing is merely illustrative of the principles of this invention which can be practiced in other embodiments.

What is claimed is:

1. Apparatus, comprising:
a sample holder having reference features and configured to receive a biological sample;
a handheld analysis module having a housing with an opening, wherein the opening is configured to receive the sample holder and wherein the analysis module comprises a chip-scale microscope having an image sensor for capturing images of the reference features and the biological sample in the sample holder as the sample holder is inserted into the opening; and
storage and processing circuitry configured to analyze the images of the biological sample based on the images of the reference features.

2. The apparatus defined in claim 1 wherein the reference features comprise at least one reference surface having a predetermined color, transmissivity, and reflectivity.

3. The apparatus defined in claim 1 wherein the reference features comprise a plurality of reference markings having a predetermined spacing from each other.

4. The apparatus defined in claim 1 wherein the reference features comprise at least one reference structure having a predetermined size.

5. The apparatus defined in claim 1 wherein the reference features and the biological sample overlap each other and are configured to be imaged together in a common imaging frame.

6. The apparatus defined in claim 1 wherein the reference features are separated from the biological sample by a distance and are configured to be imaged separately in different imaging frames.

7. The apparatus defined in claim 1 wherein the sample holder comprises a transparent portion, wherein the reference features are located in the transparent portion, and wherein the opening in the housing of the analysis module is configured to receive the transparent portion of the sample holder.

8. A method for operating a handheld diagnostic system, comprising:
placing a biological sample in a sample holder, wherein the sample holder comprises built-in reference features;
inserting the sample holder into an analysis module, wherein the analysis module comprises a chip-scale microscope having an image sensor; and
while the sample holder is being inserted into the analysis module, capturing images of the biological sample and the reference features using the chip-scale microscope.

9. The method defined in claim 8 further comprising:
with storage and processing circuitry, analyzing the images of the biological sample based on the images of the reference features.

10. The method defined in claim 9 wherein the reference features comprise at least one reference surface having a reference color and wherein analyzing the images of the biological sample based on the images of the reference features comprises determining a color associated with the biological sample based on the reference color.

11. The method defined in claim 9 wherein the reference features comprise at least one reference surface having a reference opacity and wherein analyzing the images of the biological sample based on the images of the reference features comprises determining an opacity associated with the biological sample based on the reference opacity.

12. The method defined in claim 9 wherein the reference features comprise a plurality of reference markings separated from each other by a distance and wherein analyzing the images of the biological sample based on the images of the reference features comprises determining a level of magnification of the chip-scale microscope using the reference markings.

13. The method defined in claim 12 wherein analyzing the images of the biological sample based on the images of the reference features comprises determining a size associated with the biological sample based on the level of magnification of the chip-scale microscope.

14. The method defined in claim 9 wherein the reference features comprise at least one reference structure having a reference size and wherein analyzing the images of the biological sample based on the images of the reference features comprises determining a size associated with the biological sample based on the reference size.

15. The method defined in claim 8 further comprising:
with the analysis module, transmitting sample imaging data corresponding to the images of the biological sample to a portable electronic device.

16. The method defined in claim 15 wherein the portable electronic device comprises a display, the method further comprising:
with the display, displaying sample analysis information based on the sample imaging data received from the analysis module.

17. A handheld sample holder having a sample-receiving portion and a transparent sample imaging portion, comprising:
a sample chamber in the sample-receiving portion configured to receive a biological sample;
a plurality of test chambers in the sample imaging portion, wherein each test chamber is coupled to the sample chamber by a channel;
flow control components configured to generate pressure that moves the biological sample through the channel and distributes a respective portion of the biological sample to each test chamber in the plurality of test chambers; and
reference features built into the sample imaging portion, wherein the reference features are configured to be imaged with a chip-scale microscope.

18. The handheld sample holder defined in claim 17 wherein the reference features comprise at least one reference surface having a predetermined color, transmissivity, and reflectivity.

19. The apparatus defined in claim 17 wherein the reference features comprise a plurality of reference markings having a predetermined spacing from each other.

20. The apparatus defined in claim 17 wherein the reference features comprise at least one reference structure having a predetermined size.
